(19) United States
(12) Patent Application Publication
(10) Pub. No.: US 2008/0155519 A1
(43) Pub. Date: Jun. 26, 2008

(54) Code translator

(75) Inventors: David Mulvaney, Leicestershire (GB); Ashwin Kumaraswamy, Bangalore (IN); Vassilios Chouliaras, Leicestershire (GB); Ramalingam Kannan, Haryana (IN)

Correspondence Address: HARRINGTON & SMITH, PC, 4 RESEARCH DRIVE, SHELTON, CT, 06484-6212, US

(73) Assignee: Loughborough University Enterprises Limited

(21) Appl. No.: 11/825,341

(22) Filed: Jul. 6, 2007

(30) Foreign Application Priority Data
Dec. 21, 2006 (GB) 0625451.0

(51) Int. Cl. G06F 9/45

(52) U.S. Cl. 717/143

(57) ABSTRACT

A method of automatically translating modelling language code to hardware language code including: parsing the modelling language code to extract values associated with predetermined ones of a plurality of constructs; and populating, in a predetermined manner using the extracted values, empty fields of one or more predetermined templates wherein the or each template comprises code of the hardware language.

### FIELD OF THE INVENTION

Embodiments of the present invention relate to computer code translation. In particular, they relate to automated translation of modelling language code, such as XMI, to a system level hardware language code.

### BACKGROUND TO THE INVENTION

The user interface for computer program design may be operated through a UML (unified modelling language) application that provides an export of its diagrams in XMI form. Typical diagram types are: class, activity, state transition and collaboration, an example of this can be found in the UML specification (www.uml.org).

UML allows a user's design to be represented in an object-oriented manner. The design is depicted in terms of classes that contain data (attributes) and the operations (methods) that can be performed on the data.

A class diagram defines the attributes that classes can store and the methods that operate on that data. The class diagram also shows interrelationships between classes. An activity diagram describes the sequence of methods that are called in order to perform a required operation. State transition diagrams show how the execution of the methods (that in turn modify attributes) will move the system from one state to another. Each state corresponds to a specific set of values taken by the attributes in a class. A collaboration diagram shows all the possible method calls that can take place within or between classes.

XMI (XML metadata exchange) is based on XML (extensible markup language), a format commonly used to describe structured data and its meaning in a portable fashion. The specification of XMI has been proposed by the OMG (object modelling group) standards body as a set of metamodels for representing the structured data contained in UML diagrams.

System level design languages (SLDLs) are generally built on existing languages such as C, C++ or Verilog, but with extensions that allow them to be better used for hardware description. An SLDL extends the high-level language to permit the description of one or more of the following: logic modules, hardware states, inputs and outputs, communication, synchronization, timing and concurrency. The SLDL includes constructs that allow the description of electronic hardware, or both hardware and software. A construct is a systematically arranged sentence containing a grammatically correct arrangement of terms. In a computer program it is a syntactically correct section of code that satisfies the specification of the language. Only syntactically correct code can be successfully compiled.

Hardware description languages (HDLs) are design-entry languages used as part of the electronic design automation process for generating digital circuits. Examples of HDLs are VHDL (very high-speed hardware description language) and Verilog.

We define the term ‘hardware language’ (HL) to include both SLDLs and HDLs

The description provided in an HL can be used to verify the hardware description and the operating times of the modules in the proposed hardware implementation.

### BRIEF DESCRIPTION OF THE INVENTION

It would be desirable to provide for the automated translation of modelling language code to HL code.

According to one embodiment of the invention there is provided a method of automatically translating modelling language code to HL code comprising: parsing the modelling language code to extract values associated with predetermined ones of a plurality of constructs; and populating, in a predetermined manner using the extracted values, empty fields of one or more predetermined templates wherein the or each template comprises code of the HL.

According to another embodiment of the invention there is provided a code translator for automatically translating modelling language code to HL code, the translator comprising: a parsing block for parsing the modelling language code to extract values associated with predetermined ones of a plurality of constructs; and a transformation block for populating, in a predetermined manner using the extracted values, empty fields of one or more predetermined templates wherein the or each template comprises code of the HL.

According to another embodiment of the invention there is provided a record medium embodying a computer program having computer program instructions for: parsing the modelling language code to extract values associated with predetermined ones of a plurality of constructs; and populating, in a predetermined manner using the extracted values, empty fields of one or more predetermined templates wherein the or each template comprises code of the HL.

### BRIEF DESCRIPTION OF THE DRAWINGS

For a better understanding of the present invention reference will now be made by way of example only to the accompanying drawings in which:

FIG. 1 schematically illustrates a system for translating an XMI symbolic description 2 (such as UML) into an HL language description in a two stage process;

FIG. 2A illustrates a portion of an XMI document produced from a UML tool;

FIG. 2B illustrates a UML class diagram;

FIG. 3 illustrates an example of a structured data format (Parsed XMI);

FIG. 4 illustrates a portion of a template for generating syntactically correct HL output;

FIG. 5 illustrates the results of applying SystemC SLDL templates to each class and interface in the parsed XMI code 6 illustrated in FIG. 3; and

FIG. 6 shows a software implementation in which a computer system uses computer program instructions to operate as a translator.

### DETAILED DESCRIPTION OF EMBODIMENTS OF THE INVENTION

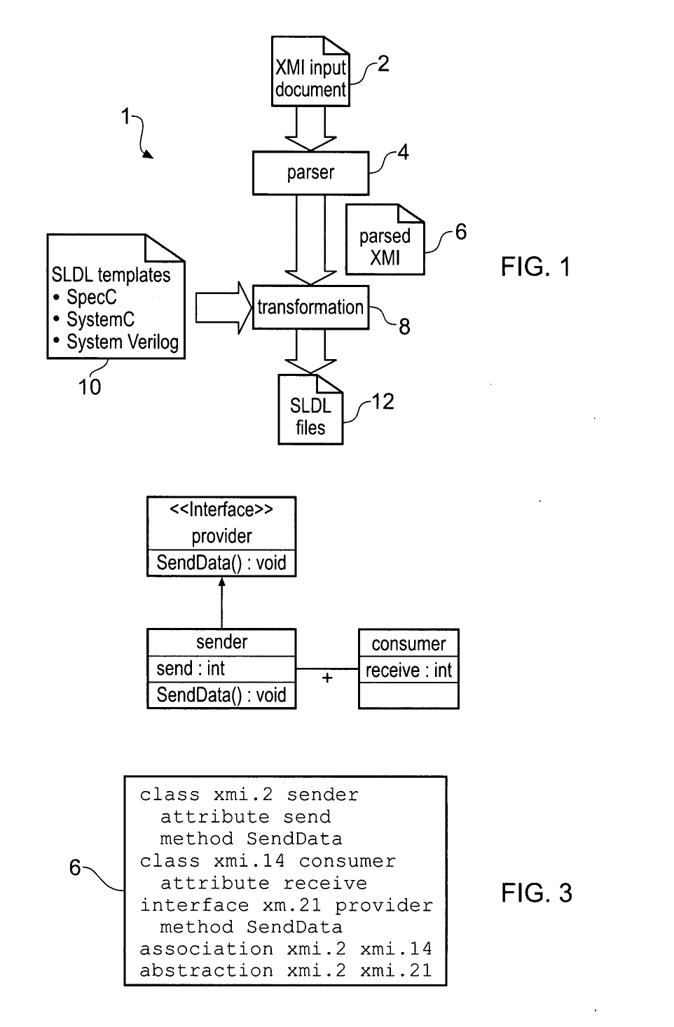

As illustrated in FIG. 1, in embodiments of the invention, an XMI symbolic description 2 (such as UML) is translated by translator 1 into an HL language description 12 in a two stage process. First, the XMI input document data structure 2 is parsed by parser block 4 to produce parsed XMI data structure 6, then with the aid of an appropriate template 10, the parsed XMI data structure 6 is converted by transformation block 8 to HL code data structure 12.

The translator 1 is designed as computer implemented modules or blocks. The front-end parser block 4 electronically converts the XMI data structure 2 from a particular UML application into a standard parsed XMI format 6. Parsed XMI 6 is a new intermediate format defined by the inventors that is independent of the UML package that actually generated the XMI 2 and is independent of the target HL 12. A different front-end parser module 4 may be necessary for each UML application, but the standard parsed XMI 6 remains in the same format. The parsed XMI contains the relevant information extracted from the XMI. Typically a large percentage (90% or more) of the XMI content is superfluous, it being a rather verbose description containing irrelevant information regarding how to redraw the UML diagram.

A back-end transformation block 8 electronically converts the standard parsed XMI format into a particular HL language. A different back-end module 8 will be necessary for each HL, but the input to the back-end module, the standard parsed XMI 6, remains in the same format. A desired back-end transformation block 8 can be created by loading the appropriate set of templates 10. There will typically be a different set of templates 10 for each HL.

The input to the parser block 4 is an XMI document or documents 2. This will be electronically parsed as a whole in a single pass through. The output of this block 4 is parsed XMI 6.

The UML tools allow a designer to draw the design diagrams (that include the class, activity, state transition and collaborative diagrams mentioned above). Each UML tool will need a way of describing the diagrams for internal use by the tool, so that, for example, they can be stored on disk to allow the designer to return later and restart where they left off. Such a diagram description is proprietary, but most UML tools also allow a diagram description to be saved in XMI format. There will normally be a (long) sequence of tags that is used to describe the elements of the diagram. The principal elements, for subsequent HL coding, aren't the shapes or positions of lines, containers or other structures in the UML drawing itself, but the elements necessary to actually produce HL code using the process shown in FIG. 1. For example, from a class diagram it is necessary to extract attribute and method names and relationships between classes.

The XMI syntax is just a collection of tags and associated values. In XMI, a tag is a sequence of tokens (other than < and >) bounded by the tokens < and >. For example, <Foundation.Core.StructuralFeature.type> is a tag containing the sequence of tokens Foundation.Core.StructuralFeature.type. A token is a printable character (strictly an ASCII character in the range 32 to 126 which includes alpha-numeric characters and others such as %, $, * and the space character).

The start of a diagram description is shown by the presence of an appropriate tag to indicate that what follows (over a possibly large sequence of tags) is a diagram description. This large sequence of tags gives information that can be extracted for that diagram by the parser block 4. The sequences of expected tokens are different for each of the UML diagram types and each diagram is parsed separately following the identification of the initial token.

For a particular UML tool, there is a list of possible token sequences that can make up a tag's contents. The list of token sequences that the parser 4 expects to find depends on the possible sequences that can be produced by the UML tool and is therefore tool dependent.

For example, in the XMI produced by ArgoUML (a popular open source package), the definition of the name of a class, attribute or method has the following format.

### <Foundation.Core.ModelElement.name> B1</Foundation.Core.ModelElement.name>

The parser 4 finds an expected token sequence and extracts a value associated with that token sequence. For example, if the XMI input document parses the token <Foundation.Core.Association . . . > then the parser will expect that the next token describes a value of the association connector.

The parser 4 may also identify errors in syntax. In the preceding example, it could identify that the association description is incomplete. An association is a relationship between two classes and an association description is complete if both classes are defined, but is incomplete if any one or both of the classes are not present in the description. This could arise because the class relationship has not been properly defined in the corresponding diagram. The parser can issue a warning to the effect that the association has no terminating classes.

The parser 4 expects to locate certain predetermined sequences of tokens within the XMI document and is able to complete a structured data format by extracting predetermined information associated with each located, predetermined sequence of tokens. The structured data contains a number of fields that are completed during the parsing process. In identifying the token sequences, the parser 4 performs a series of pattern matching operations on the XMI input.

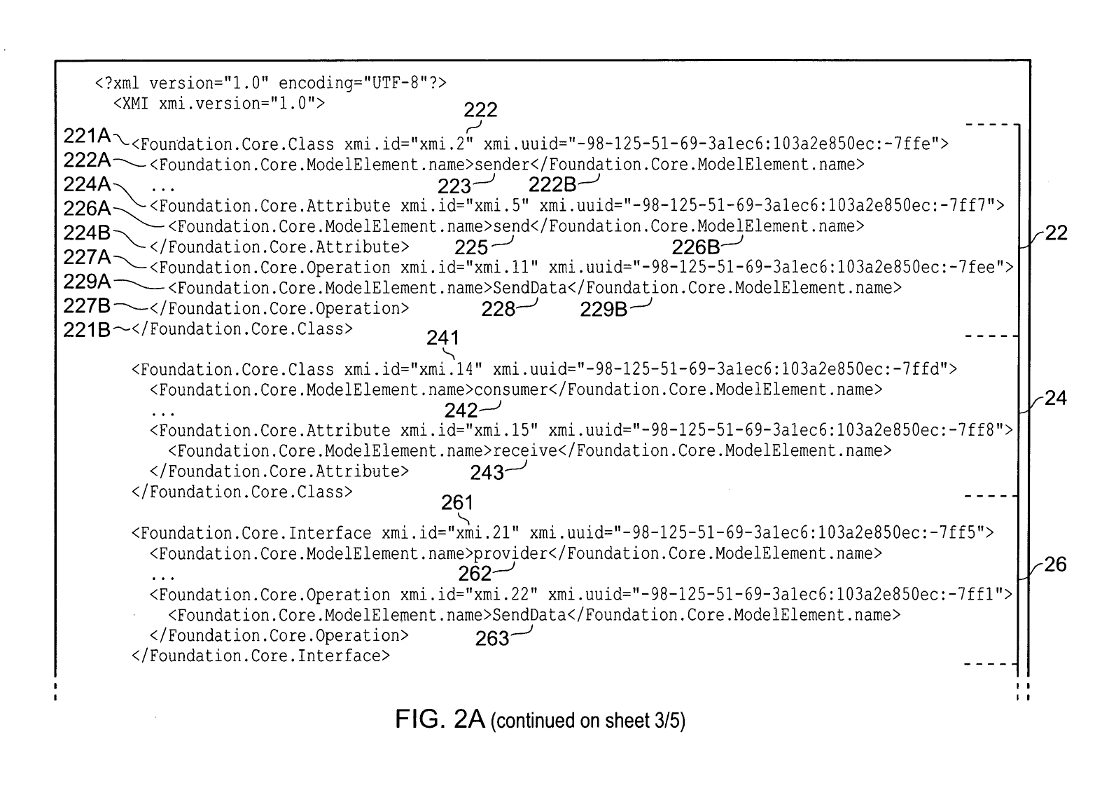

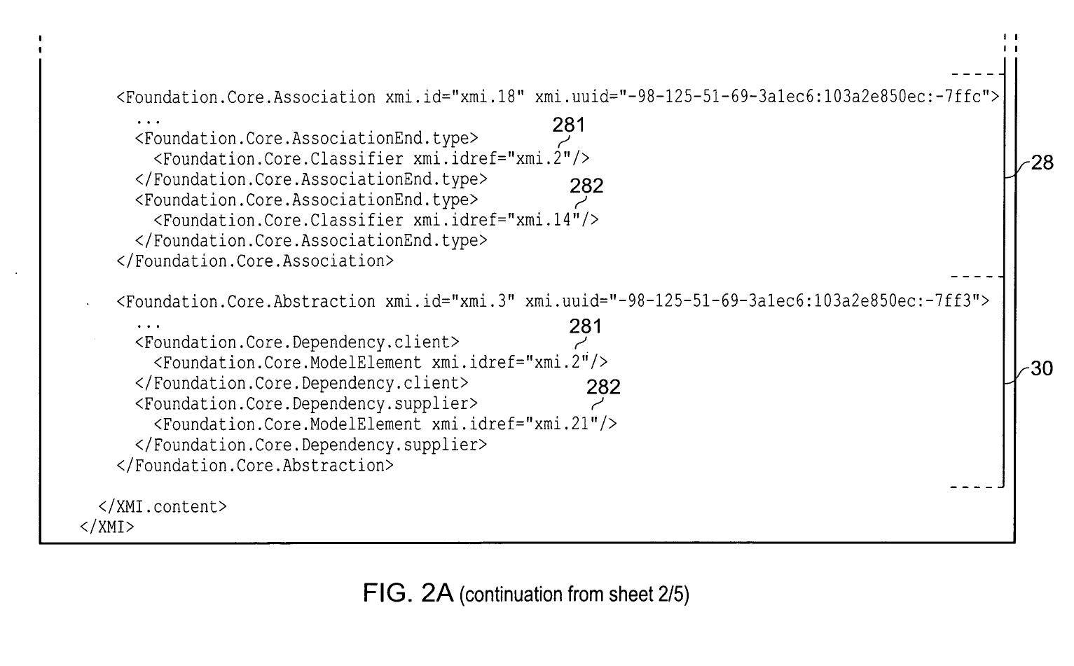

FIG. 2A illustrates a portion of an XMI document produced from a UML tool. The portion relates to a UML class diagram illustrated in FIG. 2B (shown for information only). There are five ‘modules’ 22, 24, 26, 28, 30 to the code. The module 22 is for the class ‘sender’. The module 24 is for the class ‘consumer’. The module 26 is for the interface ‘provider’. The module 28 is for the association relationship and the module 30 is for the abstraction relationship.

It will be apparent to those skilled in the art that that module 22 for the class ‘sender’ has an initial tag 221A defining an identifier ‘xmi.2’ 222 and a terminating tag 221B. The class definition is between the tags 221A and 221B. Within the class definition, a pair of tags 222A, 222B define the class name. The value 223 of the name is located between the tags 222A, 222B. Within the class definition, a pair of tags 224A, 224B define class attributes. Each attribute is identified by a value 225 between its own pair of tags 226A,226B. Within the class definition, a pair of tags 227A, 227B define methods. Each method is identified by a value 228 between its own pair of tags 229A,229B.

The module 24 similarly uses tags to define, for the class, an identifier as value 241, a name as value 242 and an attribute value 243 but no methods are defined.

The module 28 uses tags to define an association between the classes ‘sender’ and ‘consumer’ using the values 281, 282.

The module 30 uses tags to define an abstraction association between the classes ‘sender’ and ‘consumer’ using the values 281, 282.

The module 26 uses tags to define, for the interface, an identifier as value 261, a name as value 262 and a method value 263.

During the parsing process, the parser 4 uses a search mask to identify the appropriate tags, in order, and then extracts required values. The parser extracts the value 222 ‘xmi.2’, the value 223 ‘sender’, the value 225 ‘send’ and the value 228 ‘SendData’ from block 22, the value ‘xmi.14’ 241, the value ‘consumer’ 242 and the value ‘receive’ 243 from block 24, the value ‘xmi.21’ 261, the value ‘provider’ 262 and the value ‘SendData’ 263 from block 26, the value ‘xmi.2’ 281 and ‘xmi.14’ 282 from block 28 and the value ‘xmi.2’ and ‘xmi.21’ from block 30.

A syntax error in the UML document 2 can be detected by the parser 4 when the parser finds a token sequence that is not on an allowed list of (possible) token sequences. An error message can be given back to the user in the context of the UML diagram itself and is consequently user-friendly.

FIG. 3, illustrates an example of a structured data format (Parsed XMI) 6. This contains information extracted from the input XMI document 2 illustrated in FIG. 2A. The parsed XMI has a standard output.

The values extracted from a method are placed in a predetermined order, namely, the order identifier value, name value, attribute(s) value(s) (if any) and method name(s) (if any). The identifier value and name values are preceded by a ‘class’ label. The attribute(s) value(s) (if any) are preceded by a ‘attribute’ label. The method name(s) value(s) (if any) are preceded by a ‘method’ label.

The structured data format (parsed XMI) 6 is a terse rendition, with a predetermined format and syntax, of the original XMI document 2.

The principal structured data formats that can be generated by the XMI parser are datatypes, stereotypes, classes, class relationships, interfaces, attributes, functions and state machines. The format of the parsed XMI is necessarily of a predetermined general form, so that the next stage (the transformation) can be applied in an HL-specific manner.

The input to the transformation block 8 is the parsed XMI 6 and the output is HL code 12. Templates 10 appropriate to the HL language are loaded into the transformation block 8. A set of templates, particular to the target HL, is used to perform pattern matches against the entries in the parsed XMI code 6.

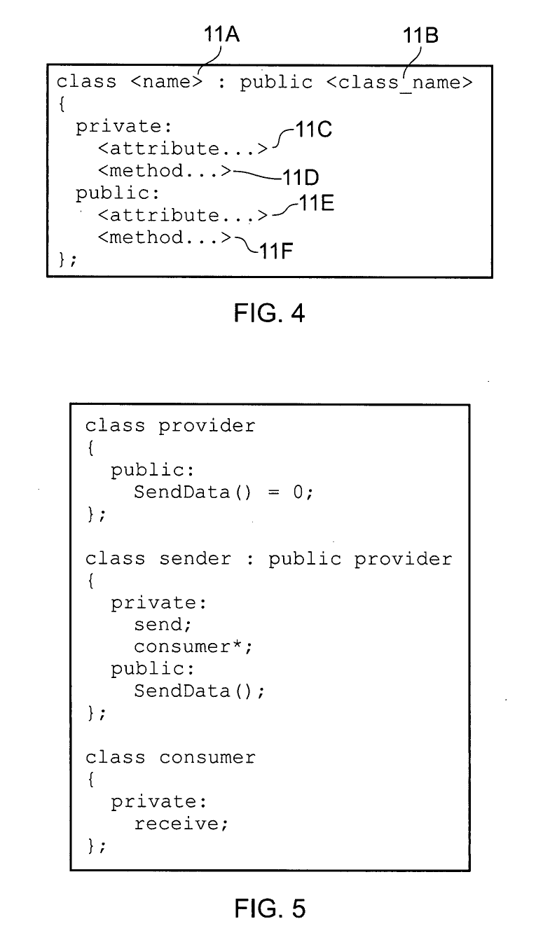

The HL templates are frameworks for generating syntactically correct HL output. A portion of a template 10 is illustrated in FIG. 4. A template 10 is a section of HL code, but with a number of blank fields 11 that need to be filled in by the transformation process.

The transformation process works through the parsed XMI file 6 looking for entries that match one of the HL templates. Once a match has been established between a section of the parsed XMI file 6 and a template, the section of the XMI code is used to populate the blank fields 11 of that template.

For example, in the SystemC SLDL, a line in the parsed XMI file 6 that begins with the keyword ‘class’ will match the ‘class’ template. Once the appropriate template has been determined, the transformation process is aware that the missing fields 11 in the template need to be filled in. The filling of the blank fields 11 is a pattern matching process. The filling of fields is not a simple one-to-one mapping, as, for example, the number of attributes, methods and relationships belonging to a class is not fixed.

The transformation will use the template for a class once the entry ‘class’ is found in the parsed XMI file. The parsed XMI can then be searched to find the class's attributes and methods, but relationships (such as the association) may only be found elsewhere in the parsed XMI file. Note that in FIG. 3, when the association for the class ‘xmi.2’ is found, the second class involved in the association (here ‘xmi.14’) may not be currently known to the transformation process.

In completing the template for a class, information is extracted from the parsed XMI 6 in order to provide the attributes and methods, as well as relationships to other classes, such as associations or inheritance (abstraction). Conditional statements and other such constructs, which help in defining the display of certain entities, may also be present in a template. As an example of the process, FIG. 5 illustrates the results of applying SystemC SLDL templates to each class and interface in the parsed XMI code 6 illustrated in FIG. 3.

As an illustration of the operation, the process of producing SystemC SLDL code from a set of templates and parsed XMI 6 involves using a computer system to:

a) Identify label ‘class’ in XMI code 6 (FIG. 3). The values associated with this class will be used to help populate a template.
b) Access the appropriate template (here the SystemC ‘class’ template) (FIG. 4)

The XMI document holds values within a predetermined structure in a predetermined order, namely, the order identifier value, name value, attribute(s) value(s) (if any) and method name(s) (if any). The identifier value and name values are preceded by a ‘class’ label. The attribute(s) value(s) (if any) are preceded by a ‘attribute’ label. The method name(s) value(s) (if any) are preceded by a ‘method’ label.

c) Populate the <name> field 11A in the class template with the name value (e.g. sender) following the class label of the current class (e.g. xmi.2).
d) Populate the <class_name> field 11B with the name value (e.g. provider) following the identifier value (e.g. xmi.21), that itself follows the identifier value of the current class (xmi.2) and the abstraction label.
e) Populate the private <attribute > field 11C with the attribute values (e.g. send) following the attribute label of the current class (e.g. xmi.2)
f) Populate the private <method > field 11D with the method values following the method label of the current class (e.g. xmi.2)
g) Populate the private <method> field 11D with the name value (e.g. consumer) following the identifier value (e.g. xmi.14), that itself follows the identifier value of the current class (xmi.2) and the association label.
h) Populate the public <attribute> field 11E with the attribute values of the class identified in <class_name> and populate the public <method> field 11F with the method values of the class identified in <class_name>.

It will be understood by those skilled in the art how these general principals may be further extended to allow the coding of HL code. Depending on the template type, a field could be one of many possible constructs, including interfaces, behaviours, channels, class names, attributes, methods, relationships and variables.

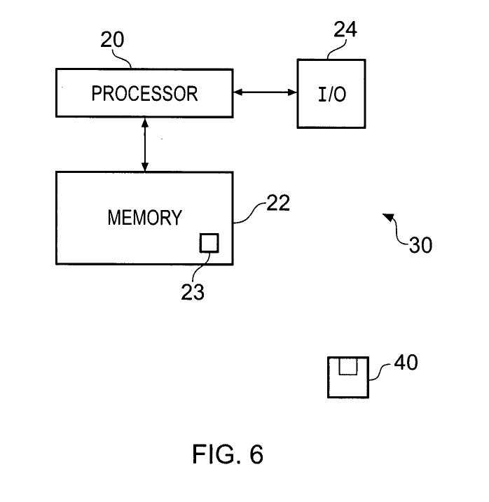

The translator 1 illustrated in FIG. 1 may be implemented in hardware or software. FIG. 6 shows a software implementation in which a computer system 30 uses computer program instructions 23 to operate as a translator.

The computer system 30 comprises a central processing unit 20 and a memory 22. The processor is arranged to write to and read from the memory 22. The processor is also arranged to provide outputs signals to input/output port 24 and to receiving input signals from the same port. The memory 22 stores computer program instructions 23 that control the operation of the computer 30 when loaded into the processor 20. The computer program instructions 23 provide the logic and routines that enables the electronic device to perform the parsing block 4 functionality and the transformation block 8 functionality. The memory 22 also stores templates 10.

The XMI input document 2 may be received by the processor via the I/O port 24 and the HL code may be provided as output by the processor from the I/O port 24.

The computer program instructions may arrive at the computer via an electromagnetic carrier signal or be copied from a physical entity 40 such as a computer program product, a memory device or a record medium such as a CDROM or DVD.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method of automatically translating modelling language code to hardware language code comprising:
parsing the modelling language code to extract values associated with predetermined ones of a plurality of constructs; and
populating, in a predetermined manner using the extracted values, empty fields of one or more predetermined templates wherein the or each template comprises code of the hardware language.

2. A method as claimed in claim 1, wherein parsing comprises:
identifying a diagram definition within the modelling language code;
identifying predetermined constructs associated with the identified diagram definition; and
extracting values associated with the identified predetermined constructs.

3. A method as claimed in claim 2, wherein a construct is a predetermined token sequence.

4. A method as claimed in claim 2, wherein the identified predetermined constructs are a predetermined subset of the possible constructs of the identified diagram definition.

5. A method as claimed in claim 1, wherein the output of the parsing stage has a standard output format having a predetermined structure and order.

6. A method as claimed in claim 5, wherein parsing creates a data structure comprising the extracted values in a predetermined order, placed in predetermined positions relative to predetermined labels.

7. A method as claimed in claim 6, wherein the predetermined order of extracted values includes identifier, name, attributes and method names

8. A method as claimed in claim 7, wherein the identifier and name values are preceded by a ‘class’ label.

9. A method as claimed in claim 8, wherein the attributes values are preceded by a ‘attribute’ label.

10. A method as claimed in claim 9, wherein the method names values are preceded by a ‘method’ label.

11. A method as claimed in claim 6, wherein the populating stage comprises:
identifying a first one of a plurality of predetermined labels;
loading a template comprising code of the hardware language with empty fields that is dependent on the identity of the first label; and
populating the fields of the loaded template in a predetermined manner using the labels of the data structure to locate an extracted value for populating a field.

12. A method as claimed in claim 11, wherein the loaded template is a class template and the extracted values provide the class attributes and methods, as well as relationships to other classes, such as associations or inheritance.

13. A method as claimed in claim 1, wherein the extracted values relate at least to class names, attributes, methods, associations and abstractions.

14. A method as claimed in claim 1, wherein parsing additionally checks the syntax of the modelling language code.

15. A method as claimed in claim 1, wherein the modelling language code is object-oriented

16. A method as claimed in claim 1, wherein the modelling language code is XMI.

17. A method as claimed in claim 1, wherein the modelling language is UML.

18. A code translator for automatically translating modelling language code to hardware language code the translator comprising:
a parsing block for parsing the modelling language code to extract values associated with predetermined ones of a plurality of constructs; and
a transformation block for populating, in a predetermined manner using the extracted values, empty fields of one or more predetermined templates wherein the or each template comprises code of the hardware language.

19. A code translator as claimed in claim 18, wherein the parsing block is arranged to:
identify a diagram definition within the modelling language code;
identify predetermined constructs associated with the identified diagram definition; and
extract values associated with the identified predetermined constructs.

20. A code translator as claimed in claim 18, wherein the transformation block is arranged to:
identify a first one of a plurality of predetermined labels;
load a template comprising code of the hardware language with empty fields that is dependent on the identity of the first label; and
populate the fields of the loaded template in a predetermined manner using the labels of the data structure to locate an extracted value for populating a field.

21. A record medium embodying a computer program having computer program instructions for:
parsing the modelling language code to extract values associated with predetermined ones of a plurality of constructs; and
populating, in a predetermined manner using the extracted values, empty fields of one or more predetermined templates wherein the or each template comprises code of the hardware language.
